(19) United States
(12) Patent Application Publication
(10) Pub. No.: US 2014/0125541 A1
(43) Pub. Date: May 8, 2014

(54) END FIRE ANTENNA APPARATUS AND ELECTRONIC APPARATUS HAVING THE SAME

(71) Applicant: SAMSUNG ELECTRONICS CO., LTD., Suwon-si (KR)

(72) Inventors: Won-bin HONG, Seoul (KR); Alexander GOUDELEV, Suwon-si (KR); Kwang-hyun BAEK, Anseong-si (KR); Young-ju LEE, Seoul (KR)

(73) Assignee: SAMSUNG ELECTRONICS CO., LTD., Suwon-si (KR)

(21) Appl. No.: 14/075,477

(22) Filed: Nov. 8, 2013

(30) Foreign Application Priority Data
Nov. 8, 2012 (KR) 10-2012-0126127

(51) Int. Cl. H01Q 21/06; H01Q 19/18

(52) U.S. Cl. CPC H01Q 21/06; H01Q 19/18
USPC 343/836; 343/893; 343/848

(57) ABSTRACT

An end fire antenna apparatus built in an electronic apparatus includes a printed circuit board (PCB), at least one main antenna built in the PCB and configured to radiate a radio wave, and a ground plate disposed on a side surface of the PCB, the ground plate being electrically isolated from the at least one main antenna. The at least one main antenna has a pillar shape uniformly extending along a thickness direction of the PCB.

### CROSS-REFERENCE TO RELATED APPLICATION

This application claims priority from Korean Patent Application No. 10-2012-0126127, filed on Nov. 8, 2012, in the Korean Intellectual Property Office, the disclosure of which is incorporated herein by reference in its entirety.

### BACKGROUND

1. Field

Apparatuses and methods consistent with exemplary embodiments relate to an end fire antenna apparatus and an electronic apparatus having the same, and more particularly, to an end fire antenna apparatus which radiates a radio wave in a direction parallel to a board and an electronic apparatus having the same.

2. Description of the Related Art

With the development of communication technology, wireless communicable electronic apparatuses have been applied to various electronic apparatus fields. In recent years, with the increasing popularity of smart phones and tablet computers, wireless communication in portable electronic apparatuses has become an essential factor.

Due to characteristics of portable apparatuses, end fire antenna apparatuses having a radio wave radiation direction parallel to a printed circuit board (PCB) are often used as antenna apparatuses built in the portable electronic apparatuses, as compared with broad side antenna apparatuses having a radio wave radiation direction perpendicular to the PCB.

As the end fire antenna apparatuses built in the portable apparatuses in the related art, planar array antennas are often used. The planar array antennas have a structure in which antennas are arranged in a direction parallel to a printed circuit board. However, when the planar array antennas are built in the electronic apparatuses, a large antenna space is necessary and thus miniaturization of the electronic apparatuses is inhibited.

### SUMMARY

One or more exemplary embodiments may overcome the above disadvantages and other disadvantages not described above. However, it is understood that one or more exemplary embodiments are not required to overcome the disadvantages described above, and may not overcome any of the problems described above.

One or more exemplary embodiments provide an end fire antenna apparatus suitable for a miniaturized design and an apparatus having the same.

According to an aspect of an exemplary embodiment, there is provided an end fire antenna apparatus built in an electronic apparatus. The end fire antenna apparatus may include: a printed circuit board (PCB); at least one main antenna built in the PCB and configured to radiate a radio wave; and a ground plate disposed on a side surface of the PCB, the ground plate being electrically isolated from the at least one main antenna. The at least one main antenna may have a pillar shape uniformly extending along a thick direction perpendicular to a longitudinal direction of the PCB.

The main antenna may have a cylindrical shape.

The main antenna may extend from the side surface of the PCB to the other side surface of the PCB.

The end fire antenna apparatus may further include at least one main antenna metal pad disposed on the other side surface of the PCB and in contact with a first terminal of the at least one main antenna.

The ground plate may include at least one separation hole to electrically isolate the at least one main antenna.

The PCB may be configured of a single board or a plurality of sub boards mutually stacked upon each other.

The end fire antenna apparatus may further include at least one sub antenna built in the PCB and disposed to be spaced apart from the at least one main antenna.

The at least one sub antenna may have a pillar shape uniformly extending along the thickness direction of the PCB.

The at least one sub antenna may extend from the side surface of the PCB into an inside of the PCB.

The end fire antenna apparatus may further include at least one sub antenna metal pad disposed in the PCB and in contact with a first terminal of the at least one sub antennas. The at least one sub antenna may be in contact with the ground plate.

The end fire antenna apparatus may include a plurality of main antennas and a plurality of sub antennas. The plurality of main antennas may be arranged in a row along a direction perpendicular to the thickness direction of the PCB and the plurality of sub antennas may be arranged in a row along the direction so that each of the main antennas is disposed across from a corresponding one of the sub antennas.

The end fire antenna apparatus may further include at least one branch antenna built in the PCB and electrically connected to the at least one main antenna.

The at least one branch antenna may have a pillar shape uniformly extending from the side surface of the PCB to another side surface of the PCB.

The end fire antenna apparatus may further include at least one main antenna metal pad disposed on another side surface of the PCB and in contact with a first terminal of the at least one main antenna. The first terminal of the at least one branch antenna may be in contact with the at least one main antenna metal pad and a second terminal of the at least one branch antenna may be in contact with the ground plate.

The end fire antenna apparatus may further include at least one reflector built in the PCB and disposed to be spaced apart from the at least one main antenna.

The at least one reflector may have a pillar shape uniformly extending along the thickness direction of the PCB.

The at least one reflector may extend from the side surface of the PCB to another side surface of the PCB.

The end fire antenna apparatus may further include at least one reflector metal pad disposed on another side surface of the PCB and in contact with a first terminal of the at least one reflector. A second terminal of the at least one reflector may be in contact with the ground plate.

The end fire antenna apparatus may include a plurality of reflectors arranged in a row along a direction of the PCB perpendicular to the thickness direction of the PCB.

According to another aspect of an exemplary embodiment, there is provided an electrode apparatus including the above-described end fire antenna apparatus.

According to the above-described various exemplary embodiments, it is possible to provide an end fire antenna apparatus suitable for miniaturization design and an electronic apparatus having the same.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a perspective view illustrating an electronic apparatus according to an exemplary embodiment;

FIG. 2 is a schematic cross-sectional view illustrating an end fire antenna apparatus according to a first exemplary embodiment provided in the electronic apparatus of FIG. 1;

FIG. 3 is a schematic plan view illustrating the end fire antenna apparatus of FIG. 2;

FIG. 4 is a schematic cross-sectional view illustrating an end fire antenna apparatus according to a second exemplary embodiment;

FIG. 5 is a schematic plan view illustrating the end fire antenna apparatus of FIG. 4;

FIG. 6 is a schematic cross-sectional view illustrating an end fire antenna apparatus according to a third exemplary embodiment;

FIG. 7 is a schematic plan view illustrating the end fire antenna apparatus of FIG. 6;

FIG. 8 is a schematic cross-sectional view illustrating an end fire antenna apparatus according to a fourth exemplary embodiment;

FIG. 9 is a schematic plan view illustrating the end fire antenna apparatus of FIG. 8;

FIG. 10 is a schematic cross-sectional view illustrating an end fire antenna apparatus according to a fifth exemplary embodiment; and

FIG. 11 is a schematic plan view illustrating the end fire antenna apparatus of FIG. 10.

### DETAILED DESCRIPTION OF THE EXEMPLARY EMBODIMENTS

Hereinafter, exemplary embodiments will be described in more detail with reference to the accompanying drawings.

In the following description, the same reference numerals are used for the same elements when they are depicted in different drawings. The matters defined in the description, such as a detailed construction and elements of the exemplary embodiments, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

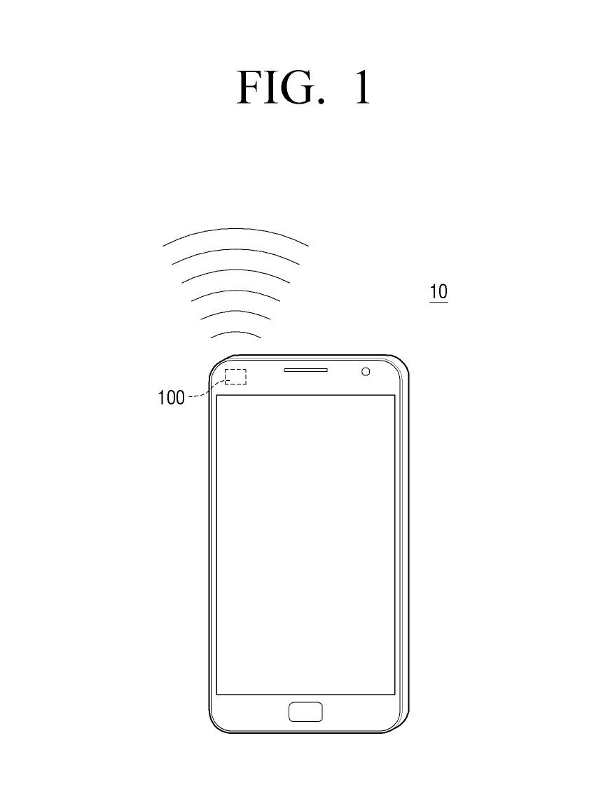

Electronic apparatuses described below may be various types of wireless communicable various apparatuses. For example, the electronic apparatuses may include, for example, display apparatuses such as televisions (TVs), cameras, portable computers, smart phones, and the like. For exemplary purposes only, an example in which the electronic apparatus is a smart phone as illustrated in FIG. 1 will be described.

FIG. 1 is a perspective view illustrating an electronic apparatus according to an exemplary embodiment.

Referring to FIG. 1, an electronic apparatus 10 includes an end fire antenna apparatus 100.

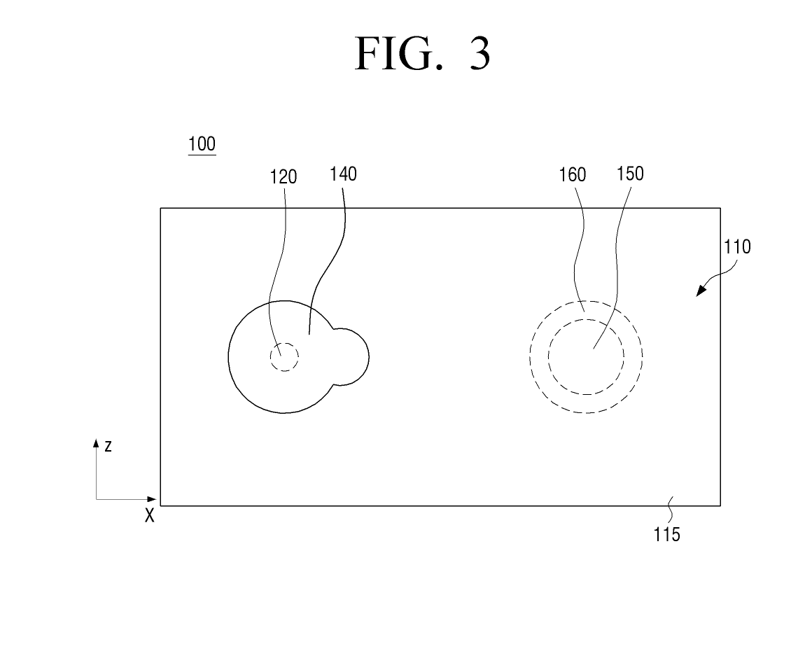

The end fire antenna apparatus 100 may be built in the electronic apparatus 10 and may radiate a radio wave in a direction parallel to a printed circuit board (PCB) (110 of FIG. 3) and radiate the radio wave in a direction parallel to a side of the electronic apparatus 10. The end fire antenna apparatus 100 according to the exemplary embodiment may be manufactured in a fine size and built in the electronic apparatus 10. Thus, miniaturization of the electronic device 10 may be implemented. Hereinafter, the end fire antenna apparatus 100 will be described in detail with reference to accompanying drawings.

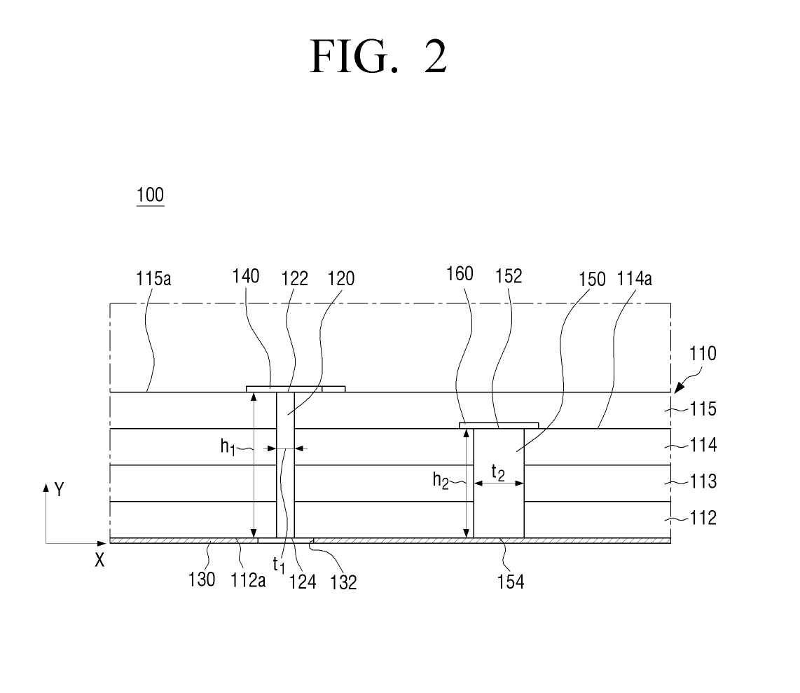

FIG. 2 is a schematic cross-sectional view illustrating an end fire antenna apparatus according to a first exemplary embodiment included in the electronic apparatus of FIG. 1 and FIG. 3 is a schematic plan view illustrating the end fire antenna apparatus of FIG. 2.

Referring to FIGS. 2 and 3, an end fire antenna apparatus 100 includes a PCB 110, a main antenna 120, a ground plate 130, a main antenna metal pad 140, a sub antenna 150, and a sub antenna metal pad 160.

The PCB 110 may be formed by stacking a plurality of sub boards 112, 113, 114, and 115. In the exemplary embodiment, the PCB 110 is configured such that the first sub board 112, the second sub board 113, the third sub board 114, and the fourth sub board 115 are sequentially stacked, will be described. However, the PCB 110 is not limited thereto and the PCB 110 may, for example, include a single board or another number of boards. The top and bottom of the stack of sub boards 112, 113, 114 and 115 form side surfaces along a longitudinal direction (an X-direction).

The main antenna 120 is a radiating element configured to radiate a radio wave for wireless communication and is built in the PCB 110. The main antenna 120 uniformly extends along the thickness direction (a Y-direction) of the PCB 110. Specifically, the main antenna 120 extends from an upper surface 115a of the PCB 110 to a lower surface 112a of the PCB 110. That is, a first end 122 of the main antenna 120 is disposed on the upper surface 115a of the PCB 110 and a second end 124 of the main antenna 120 is disposed on the lower surface 112a of the PCB 110. According to an exemplary embodiment, the thickness direction of the PCB 110 is shorter than a longitudinal direction (an X-direction) of the PCB 110.

However, according to other exemplary embodiments, the structure of the main antenna is not limited thereto and when the main antenna is built in the PCB, the main antenna may be built to have a different structure. For example, the main antenna may be built to have a structure in which the main antenna extends from the first sub board of the PCB 110 to a second sub board of the PCB, a structure in which the main antenna extends from the first sub board to a third sub board, or another structure. Further, the main antenna may penetrate the PCB and extend to protrude from the PCB. That is, a height h1 of the main antenna 120 may be suitably modified according to the design.

Therefore, the main antenna 120 has a pillar shape having a uniform thickness t1 in the thickness direction (Y-direction) of the PCB 110. In the exemplary embodiment, the main antenna 120 may have a cylindrical shape, but the shape of the main antenna is not limited thereto according to other exemplary embodiments, and the main antenna may have a different shape such as an elliptical pillar shape or a rectangular pillar shape.

The main antenna 120 is formed through a general via process. That is, the main antenna 120 may be formed by filling a via hole with a conductive material, the via hole formed in the first sub board 112, the second sub board 113, the third sub board 114, and the fourth sub board 115.

Since the main antenna 120 is formed in the PCB 110 in the thickness direction (Y-direction) of the PCB 110, a total length of the PCB 110 may be reduced as compared with a planar array antenna extending in a length direction (an X-direction) of the PCB 110. Thus, the end fire antenna apparatus 100 enables miniaturization in a dimension (e.g., thickness direction) of the electronic apparatus 10.

The ground plate 130 is disposed on the lower surface 112a of the PCB 110. Like the main antenna 120, the ground plate 130 is formed of a conductive material. The ground plate 130 is electrically isolated from the main antenna 120 to cause a voltage difference between the main antenna 120 and the ground plate 130. According to an exemplary embodiment, to achieve the electrical isolation, a separation hole 132 is provided in the ground plate 130. The separation hole 132 is formed to have a thickness larger than the thickness t1 of the main antenna 120 in a region thereof below the second end 124 of the main antenna 120 so that the main antenna 120 and the ground plate 130 are not in contact with each other.

The main antenna metal pad 140 is disposed on the upper surface 115a of the PCB 110 and is in contact with the first end 122 of the main antenna 120. The main antenna metal pad 140 is connected to a power supply unit (not shown) together with the ground plate 130 to supply power to the main antenna 120.

The main antenna metal pad 140 also increases capacitance of the end fire antenna apparatus 100. The capacitance of the main antenna metal pad 140 is proportional to an area thereof and thus the main antenna metal pad 140 may be designed in a suitable size by considering frequency. As the capacitance of the end fire antenna apparatus 100 is increased, the height h1 of the main antenna 120 may be correspondingly reduced. Thus, the end fire antenna apparatus 100 reduces the total thickness of the PCB 110 to enable miniaturization of the electronic apparatus 10.

The sub antenna 150 is built in the PCB 110, is disposed in front of the main antenna 120, and is spaced apart from the main antenna 120 along the length direction (X-direction) of the PCB 110. Thus, when the main antenna 120 radiates a radio wave, most of the radio wave may be radiated toward the sub antenna 150.

The sub antenna 150 uniformly extends from the lower surface 112a of the PCB 110 into the inside of the PCB 110 along the thickness direction (Y direction) of the PCB 110, to a constant depth. Specifically, a first end 152 of the sub antenna 150 is disposed on an upper surface 114a of the third sub board 114 and a second end 154 of the sub antenna 150 is disposed on the lower surface 112a of the PCB 110. Here, a height h2 of the sub antenna 150 may be suitably modified according to preferred design characteristics, in a similar manner as the above-described main antenna 120.

The second end 154 of the sub antenna 150 is in contact with the ground plate 130. According to an exemplary embodiment, the sub antenna 150 may be implemented as a passive antenna because noncontact with the ground plate 130 is not necessarily required. Therefore, the ground plate 130 may not include a separation hole in a region thereof below the second end 154 of the sub antenna 150, unlike the main antenna 120.

According to an exemplary embodiment, the sub antenna 150 has a pillar shape similar to the main antenna 120. According to an exemplary embodiment, the sub antenna 150 having a cylindrical shape will be described. However, the shape of the sub antenna 150 is not limited thereto according to other exemplary embodiments, and the sub antenna 150 may have a different shape such as an elliptical pillar shape or a rectangular pillar shape. The sub antenna 150 is formed through a via process, similar to the main antenna 120.

The sub antenna metal pad 160 is disposed in the PCB 110 and is in contact with the first end 152 of the sub antenna 150. Specifically, the sub antenna metal pad 160 is disposed between the third sub board 114 and the fourth sub board 115.

The sub antenna metal pad 160 is not connected to a power supply unit (not shown), unlike the main antenna metal pad 140, and has a function to increase the capacitance of the sub antenna 150. Thus, since the end fire antenna apparatus 100 enables a reduction of the height h2 of the sub antenna 160, the end fire antenna apparatus 100 achieves a reduction in the total thickness of the PCB 110 to obtain the miniaturization of the apparatus.

Hereinafter, an operation of the end fire antenna apparatus 100 will be described.

The end fire antenna apparatus 100 performs radio wave radiation of the main antenna 120 when the power is supplied to the main antenna 120 from the power supply unit (not shown). Here, the radio wave is mostly radiated along the length direction (X-direction) of the PCB 110. That is, the radio wave is mostly radiated towards the sub antenna 150. When an electromagnetic field is generated through the radio wave radiation of the main antenna 120, the sub antenna 150 amplifies the radiated radio wave.

According to this configuration, the end fire antenna apparatus 100 enables the radiating of most of the radio wave in one direction (to the right direction in FIG. 2) of the length direction (X-direction) of the PCB 110 and also enables the amplification of the radiated radio wave, thereby increasing a radiation efficiency of the radio wave.

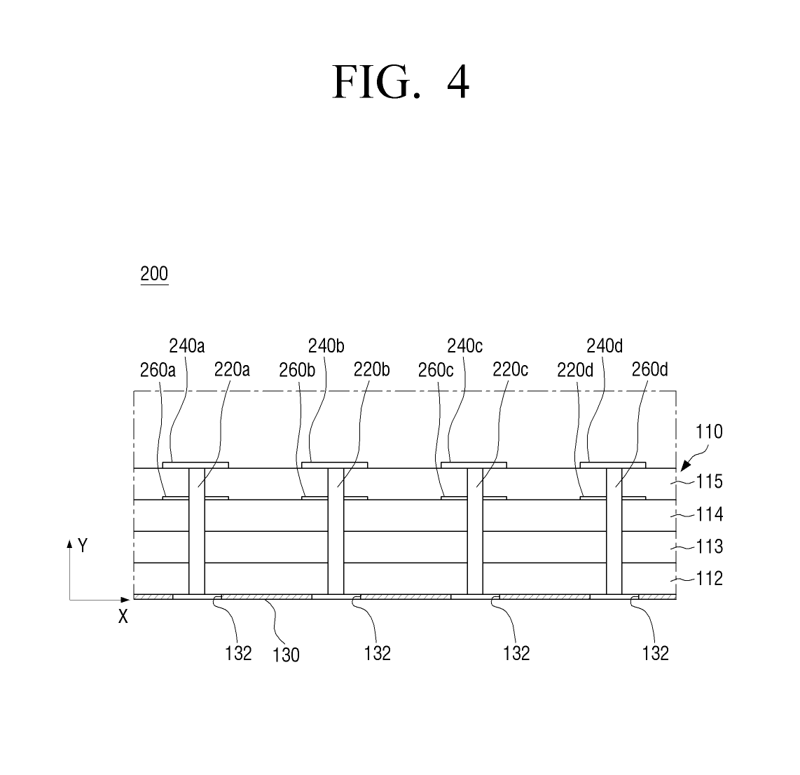

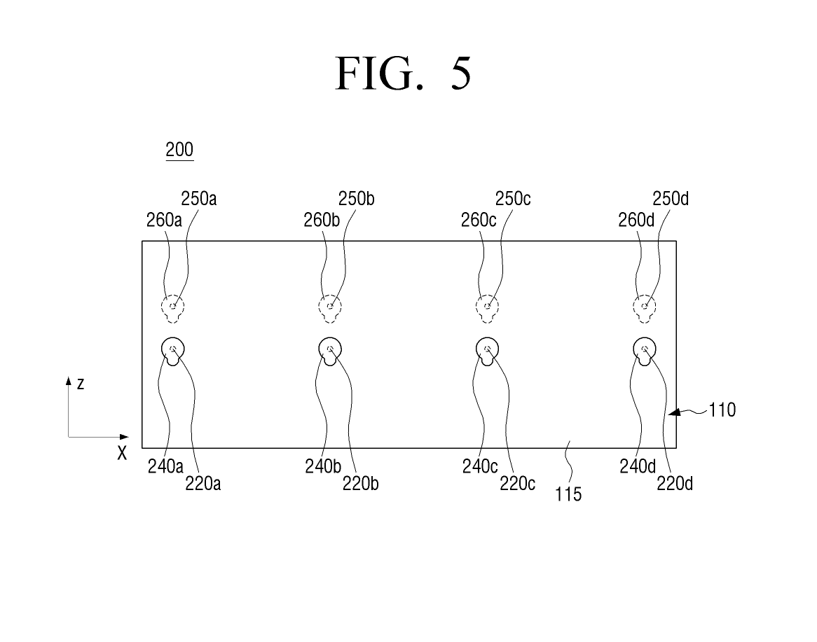

FIG. 4 is a schematic cross-sectional view illustrating an end fire antenna apparatus according to a second exemplary embodiment and FIG. 5 is a schematic plan view illustrating the end view antenna apparatus of FIG. 4.

The same reference numerals in the exemplary embodiment are used substantially for the same elements in the above-described first exemplary embodiment and a detailed description thereof will be omitted.

Referring to FIGS. 4 and 5, an end fire antenna apparatus 200 includes a PCB 110, main antennas 220a, 220b, 220c, and 220d, a ground plate 130, main antenna metal pads 240a, 240b, 240c, and 240d, sub antennas 250a, 250b, 250c, and 250d, and sub antenna metal pads 260a, 260b, 260c, and 260d.

A plurality of main antennas 220a, 220b, 220c, and 220d are included in the end fire antenna apparatus 200. In the exemplary embodiment, the main antennas including the first main antenna 220a, the second main antenna 220b, the third main antenna 220c, and the fourth main antenna 220d, that is, four main antennas, will be described. However, the configuration of the main antennas is not limited thereto according to other exemplary embodiments and the number of main antennas may be suitably modified according to design needs.

The first to fourth main antennas 220a to 220d are arranged in a row along a length direction (an X-direction) of the PCB 110. However, the arrangement of the main antennas is not limited thereto and the first to fourth main antennas 220a to 220d may be arranged in a row along a width direction (a Z-direction) of the PCB 110. Further, the first to fourth main antennas 220a to 220d may be arranged in a row along any direction perpendicular to a thickness direction (a Y-direction) of the PCB 110.

The ground plate 130 includes four separation holes 132 for electrical isolation from the first main antenna 220a, the second main antenna 220b, the third main antenna 220c, and the fourth main antenna 220d, respectively.

A plurality of main antenna metal pads 240a, 240b, 240c, and 240d are included to correspond to the respective main antennas 220a, 220b, 220c, and 220d. In the exemplary embodiment, main antenna metal pads including the first main antenna metal pad 240a, the second main antenna metal pad 240b, the third main antenna metal pad 240c, and the fourth main antenna metal pad 240d, that is, four main antenna metal pads will be described, however it is understood that a different number of main antenna metal pads may be implemented according to other exemplary embodiments.

A plurality of sub antennas 250a, 250b, 250c, and 250d are included in the end fire antenna apparatus 200. In the exemplary embodiment, sub antennas including the first sub antenna 250a, the second sub antenna 250b, the third sub antenna 250c, and the fourth sub antenna 250d, that is, four sub antennas, will be described. However, the configuration of the sub antennas is not limited thereto according to other exemplary embodiments and the number of sub antennas may be suitably modified according to design needs.

The first to fourth sub antennas 250a to 250d are arranged in a row along the length direction (X-direction) of the PCB 110. However, the arrangement of the sub antennas is not limited thereto and the first to fourth sub antennas 250a to 250d may be arranged in a row along the width direction (Z-direction) of the PCB 110. Further, the first to fourth sub antennas 250a to 250d may be arranged in a row along any direction perpendicular to the thickness direction (Y-direction) of the PCB 110.

The first to fourth sub antennas 250a to 250d may be disposed to face the first to fourth main antennas 220a to 220d. Specifically, the first sub antenna 250a is disposed to face the first main antenna 220a, the second sub antenna 250b is disposed to face the second main antenna 220b, the third sub antenna 250c is disposed to face the third main antenna 220c, and the fourth sub antenna 250d is disposed to face the fourth main antenna 220d.

A plurality of sub antenna metal pads 260a, 260b, 260c, and 260d are included to correspond to the respective sub antennas 250a, 250b, 250c, and 250d. In the exemplary embodiment, sub antenna metal pads including the first sub antenna metal pad 260a, the second sub antenna metal pad 260b, the third sub antenna metal pad 260c, and the fourth sub antenna metal pad 260d, that is, four sub antenna metal pads, will be described.

Since the plurality of main antennas 220a, 220b, 220c, and 220d and the plurality of sub antennas 250a, 250b, 250c, and 250d are configured to form an array antenna, the end fire antenna apparatus 200 enables a greater radio wave radiation efficiency as compared with a single antenna.

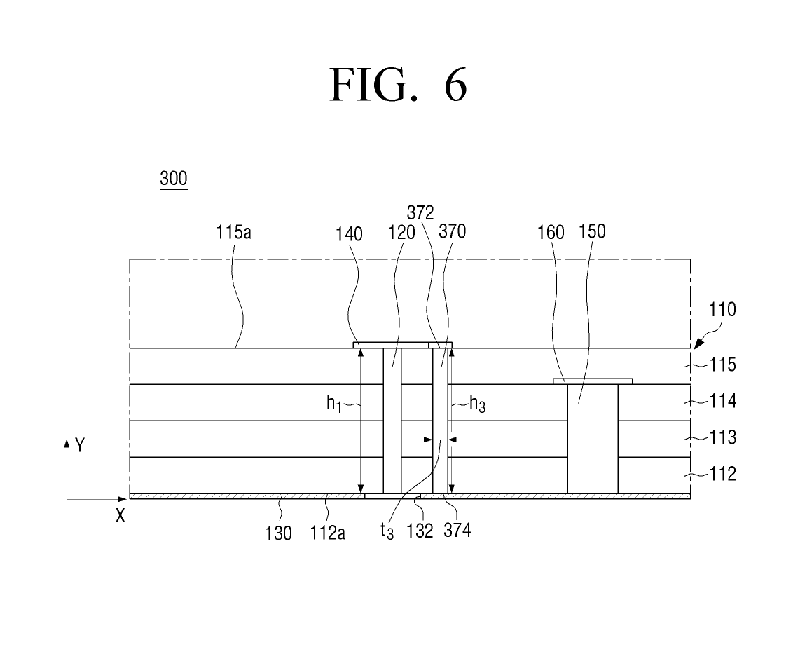

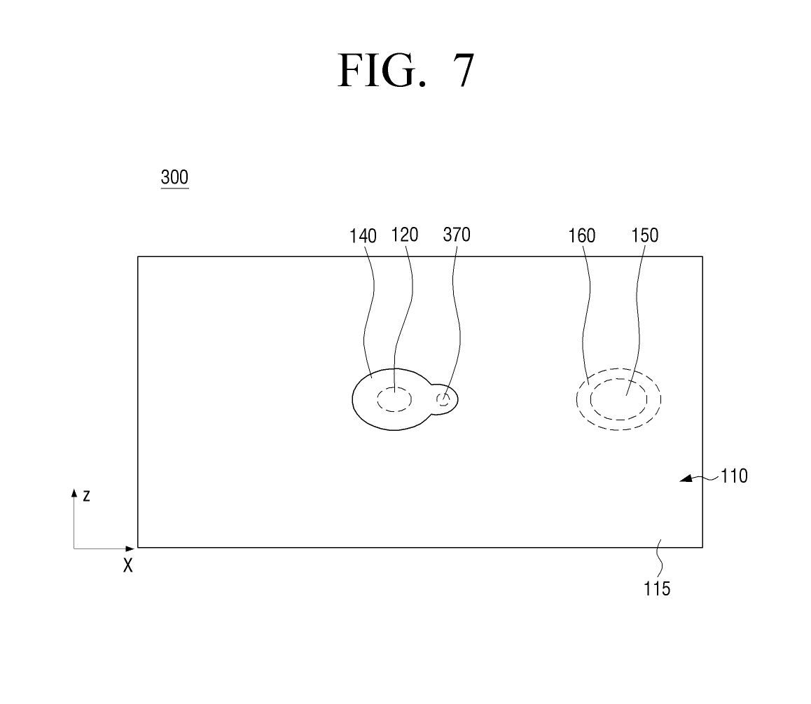

FIG. 6 is a schematic cross-sectional view illustrating an end fire antenna apparatus according to a third exemplary embodiment and FIG. 7 is a schematic plan view illustrating the end fire antenna apparatus of FIG. 6.

The same reference numerals in the exemplary embodiment are used substantially for the same elements in the above-described first and second exemplary embodiments and a detailed description thereof will be omitted.

Referring to FIGS. 6 and 7, an end fire antenna apparatus 300 includes a PCB 110, a main antenna 120, a ground plate 130, a main antenna metal pad 140, a sub antenna 150, a sub antenna metal pad 160, and a branch antenna 370.

The branch antenna 370 is built in the PCB 110 and has a pillar shape uniformly extending along a thickness direction (a Y-direction) of the PCB. Specifically, the branch antenna 370 extends from an upper surface 115a of the PCB 110 to a lower surface 112a of the PCB 110. That is, a first end 372 of the branch antenna 370 is disposed on the upper surface 115a of the PCB 110 and a second end 374 of the branch antenna 370 is disposed on the lower surface 112a of the PCB 110.

According to this configuration, the branch antenna 370 has a pillar shape having a uniform thickness t3 in a thickness direction (a Y-direction) of the PCB 110. Here, the branch antenna 370 having a cylindrical shape and formed through a via process like the main antenna and the sub antenna in the above-described exemplary embodiments will be described.

The branch antenna 370 is electrically connected to the main antenna 120 and extends substantially to a height h1 of the main antenna 120. The first end 372 of the branch antenna 370 is in contact with the main antenna metal pad 140 so that the branch antenna 370 is electrically connected to the main antenna 120. On the other hand, the second end 374 of the branch antenna 370 is in contact with the ground plate 130. Here, the second end 374 of the branch antenna 370 may not be in contact with the ground plate 130. Alternatively, to ensure the height h3 of the branch antenna 370 to a maximum, the second end 374 of the branch antenna 370 may be in contact with the ground plate 130.

In general, when the height of a main antenna in an antenna apparatus is increased, the radiation of the radio wave is increased. However, in the antenna apparatus, when the height of the main antenna is simply increased, an additional space corresponding to the increased height of the antenna is required in the thickness direction of the PCB.

The end fire antenna apparatus 300 according to the exemplary embodiment enables to extend the height h1 of the main antenna 120 due to the branch antenna without requiring an additional space in the thickness direction (Y-direction) of the PCB 110. That is, the end fire antenna apparatus 300 according to the exemplary embodiment enables a substantial increase in the height of the main antenna 120 due to the branch antenna 370 by the height h3 of the branch antenna 370. Therefore, the end fire antenna apparatus 300 enables further miniaturization of the electronic apparatus 10 and further increases the radiation efficiency of the radio wave.

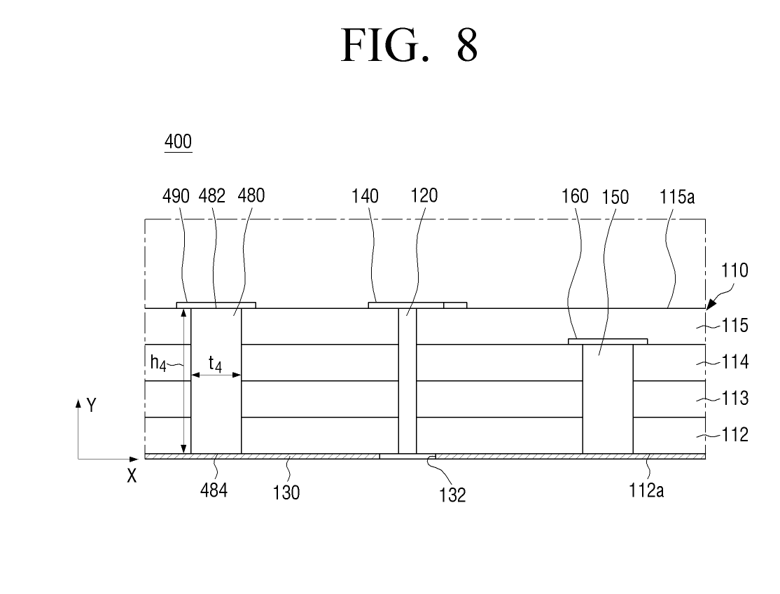

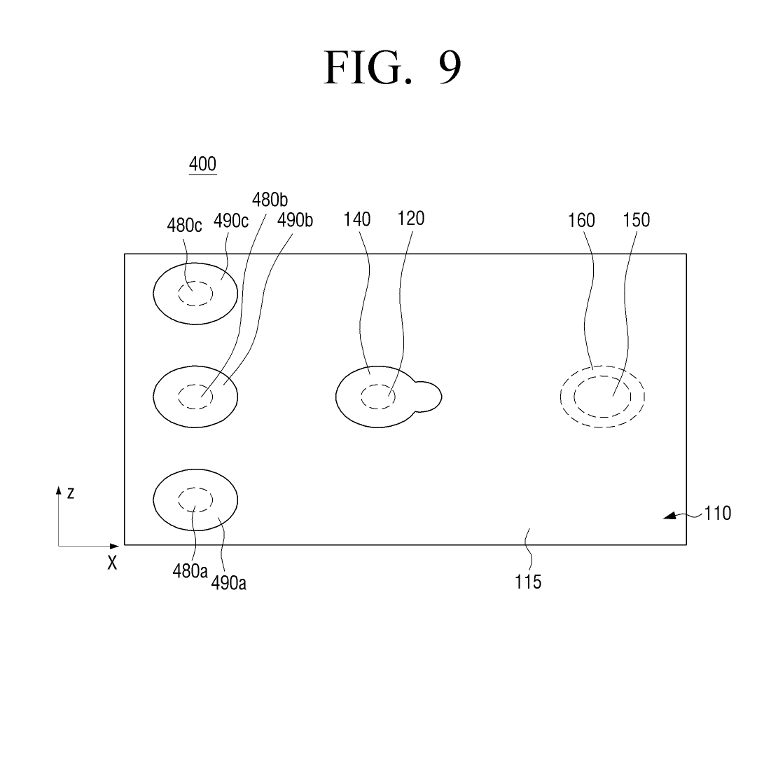

FIG. 8 is a schematic cross-sectional view illustrating an end fire antenna apparatus according to a fourth exemplary embodiment and FIG. 9 is a schematic plan view illustrating the end fire antenna apparatus of FIG. 8.

The same reference numerals in the exemplary embodiment are used substantially for the same elements in the above-described first to third exemplary embodiments and a detailed description thereof will be omitted.

Referring to FIGS. 8 and 9, an end fire antenna apparatus 400 includes a PCB 110, a main antenna 120, a ground plate 130, a main antenna metal pad 140, a sub antenna 150, a sub antenna metal pad 160, a reflector 480 and a reflector metal pad 490.

The reflector 480 is configured to reflect a radio wave and is built in the PCB 110. The reflector 480 is disposed to be spaced from the main antenna 120 and is disposed to face the sub antenna 150 with the main antenna 120 being interposed therebetween.

The reflector 480 uniformly extends along a thickness direction (a Y-direction) of the PCB 110, similar to the main antenna 120 and the sub antenna 150. Specifically, the reflector 480 extends from an upper surface 115a of the PCB 110 to a lower surface 112a of the PCB 110. That is, a first end 482 of the reflector 480 is disposed on an upper surface 115a of the PCB 110 and a second end 384 of the reflector 480 is disposed on the lower surface 112a of the PCB 110 to be in contact with the ground plate 130.

However, the configuration of the reflector 480 is not limited thereto and a height h4 of the reflector 480 may be suitably modified according to the design characteristics, similar to lithe above-described main antenna 120. The reflector 480 has a pillar shape having a uniform thickness t4 in the thickness direction (Y-direction) of the PCB 110, similar to the above-described main antenna 120 and the sub antenna 150. In the exemplary embodiment, the reflector 480 having a cylindrical shape similar to the main antenna 120 and the sub antenna 130 in the above-described exemplary embodiments will be described. In the exemplary embodiment, the reflector 480 is formed through a via process like the main antenna 120 and the sub antenna 130 in the above-described exemplary embodiments.

According to an exemplary embodiment, the end fire antenna apparatus 400 includes a plurality of reflectors 480. In the exemplary embodiment, reflectors including the first reflector 480a, the second reflector 480b, and the third reflector 480c, that is, three reflectors, will be described. However, it is understood that the number of reflectors 480 is not limited to three according to other exemplary embodiments, and may be suitably modified according to the design.

The first to third reflectors 480a to 480c are arranged in a row along the width direction (Z-direction) of the PCB 110. However, according to other exemplary embodiments, the arrangement of the reflectors is not limited thereto and the arrangement of the first to third reflectors 480a to 480c may be modified to be suitable for the reflection of the radio wave.

The reflector metal pad 490 is configured to increase capacitance of the reflector 480, similar to the above-described sub antenna metal pad 160, and is disposed on the upper surface 115a of the PCB 110 to be in contact with a first end 482 of the reflector 480.

A plurality of reflector metal pads 490 is included to correspond to the plurality of reflectors 480a, 480b, and 480c. In the exemplary embodiment, first to third reflector metal pads 490a to 490c are included to correspond to the first to third reflectors 490a to 490c. According to this configuration, the first to third reflector metal pads 490a to 490c are also arranged in a row along a width direction (a Z-direction) of the PCB 110.

When the main antenna 120 radiates a radio wave, most of the radio wave is radiated toward the sub antenna 150 (in a +X-direction). However, a portion of the radio wave may be radiated toward the reflector 480 (in a −X direction). At this time, the reflector 480 reflects the radio wave radiated toward the reflector 480 (in a −X-direction) toward the sub antenna 150 (in a +X-direction side). Therefore, the end fire antenna apparatus 400 enables the transfer of a portion of the radio wave radiated toward the reflector 480 (in a −X-direction) toward the sub antenna 150 (in a +X-direction) and thereby enables an increase in the radiation efficiency of the radio wave.

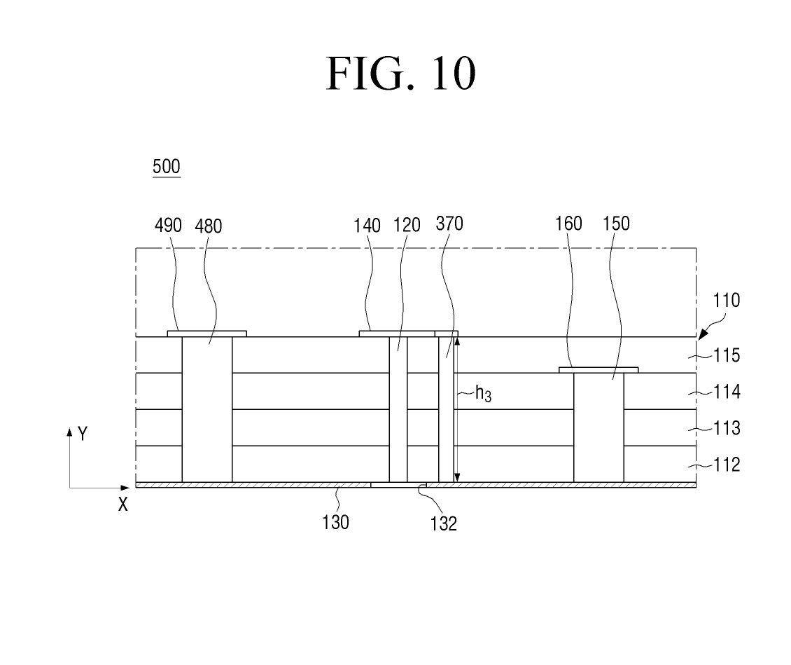

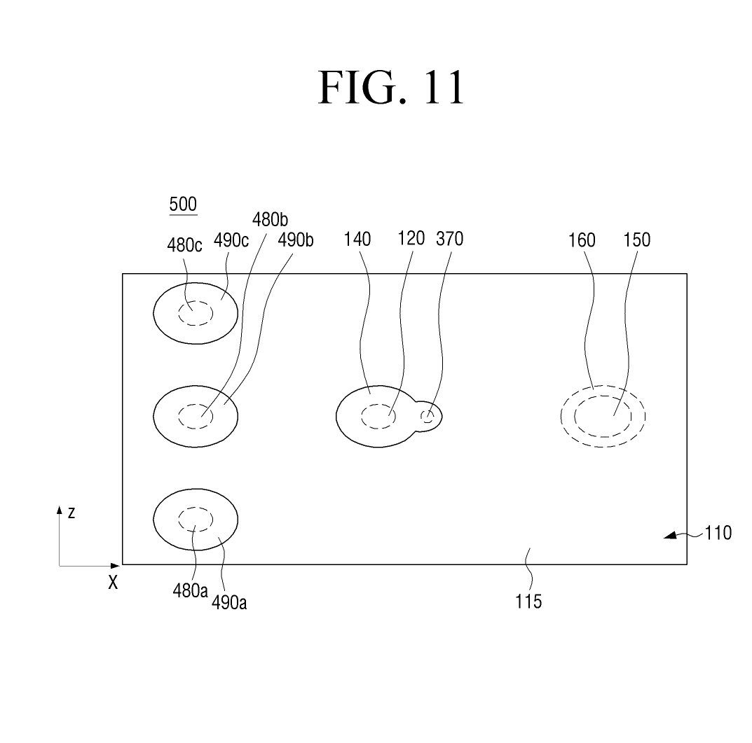

FIG. 10 is a schematic cross-sectional view illustrating an end fire antenna apparatus according to a fifth exemplary embodiment and FIG. 11 is a schematic plan view illustrating the end fire antenna apparatus of FIG. 10.

The same reference numerals in the exemplary embodiment are used substantially for the same elements in the above-described first to fourth exemplary embodiments and a detailed description thereof will be omitted.

Referring to FIGS. 10 and 11, an end fire antenna apparatus 500 includes a PCB 110, a main antenna 120, a ground plate 130, a main antenna metal pad 140, a sub antenna 150, a sub antenna metal pad 160, a branch antenna 370, a reflector 480, and a reflector metal pad 490.

The end fire antenna apparatus 500 further include the branch antenna 370 as compared with the end fire antenna apparatus 400 in the fourth exemplary embodiment. Therefore, in the end fire antenna apparatus 500, a height of the main antenna 120 is substantially increased by a height h3 of the branch antenna 370, and thus the miniaturization of the electronic apparatus 10 is promoted and the radiation efficiency of the radio wave is further increased.

The foregoing exemplary embodiments and advantages are merely exemplary and are not to be construed as limiting the exemplary embodiments. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

1. An end fire antenna apparatus built in an electronic apparatus, comprising:
a printed circuit board (PCB);
at least one main antenna built in the PCB and configured to radiate a radio wave; and
a ground plate disposed on a side surface of the PCB, the ground plate being electrically isolated from the at least one main antenna,
wherein the at least one main antenna has a pillar shape uniformly extending along a thickness direction perpendicular to a longitudinal direction of the PCB.

2. The end fire antenna apparatus as claimed in claim 1, wherein the at least one main antenna has a cylindrical shape.

3. The end fire antenna apparatus as claimed in claim 1, wherein the at least one main antenna extends from the side surface of the PCB to another side surface of the PCB.

4. The end fire antenna apparatus as claimed in claim 4, further comprising a main antenna metal pad disposed on the other side surface of the PCB and in contact with a first terminal of the main antenna.

5. The end fire antenna apparatus as claimed in claim 1, wherein the ground plate includes at least one separation hole configured to electrically isolate the at least one main antenna.

6. The end fire antenna apparatus as claimed in claim 1, wherein the PCB is configured of a single board or a plurality of sub boards mutually stacked upon each other.

7. The end fire antenna apparatus as claimed in claim 1, further comprising at least one sub antenna built in the PCB and disposed to be spaced apart from the at least one main antenna.

8. The end fire antenna apparatus as claimed in claim 7, wherein of the at least one sub antenna has a pillar shape uniformly extending along the thickness direction of the PCB.

9. The end fire antenna apparatus as claimed in claim 7, wherein the at least one sub antenna extends from the side surface of the PCB into an inside of the PCB.

10. The end fire antenna apparatus as claimed in claim 7, further comprising at least one sub antenna metal pad disposed in the PCB and in contact with a first terminal of the at least one sub antenna,
wherein the at least one sub antenna is in contact with the ground plate.

11. The end fire antenna apparatus as claimed in claim 7, wherein the at least one main antenna comprises a plurality of main antennas and the at least one sub antenna comprises a plurality of sub antennas,
wherein the plurality of main antennas are arranged in a row along a direction perpendicular to the thickness direction of the PCB, the plurality of sub antennas are arranged in a row along the direction, and each of the main antennas is disposed across from a corresponding one of the sub antennas.

12. The end fire antenna apparatus as claimed in claim 1, further comprising at least one branch antenna built in the PCB and electrically connected to the at least one main antenna.

13. The end fire antenna apparatus as claimed in claim 12, wherein of the at least one branch antenna has a pillar shape uniformly extending from the side surface of the PCB to another side surface of the PCB.

14. The end fire antenna apparatus as claimed in claim 12, further comprising at least one main antenna metal pad disposed on another side surface of the PCB and in contact with a first terminal of the at least one main antenna,
wherein a first terminal of the at least one branch antenna is in contact with the at least one main antenna metal pad and a second terminal of the at least one branch antenna is in contact with the ground plate.

15. The end fire antenna apparatus as claimed in claim 1, further comprising at least one reflector built in the PCB and disposed to be spaced apart from the at least one main antenna.

16. The end fire antenna apparatus as claimed in claim 15, wherein the at least one reflector has a pillar shape uniformly extending along the thickness direction of the PCB.

17. The end fire antenna apparatus as claimed in claim 15, wherein the at least one reflector extends from the side surface of the PCB to another side surface of the PCB.

18. The end fire antenna apparatus as claimed in claim 15, further comprising at least one reflector metal pad disposed on another side surface of the PCB and in contact with a first terminal of the at least one reflector,
wherein a second terminal of the at least one reflector is in contact with the ground plate.

19. The end fire antenna apparatus as claimed in claim 15, wherein the at least one reflector comprises a plurality of reflectors arranged in a row along a direction of the PCB perpendicular to the thickness direction of the PCB.

20. An electronic device comprising:
the end fire antenna apparatus according to any claim of claim 1.
